(19) United States
(12) Patent Application Publication
(10) Pub. No.: US 2026/0212220 A1
(43) Pub. Date: Jul. 23, 2026

(54) PREDICTION OF A CHANGE IN CONTROL FLOW

(71) Applicant: Arm Limited, Cambridge (GB)

(72) Inventors: Houdhaifa BOUZGUARROU, Valbonne (FR); Michael Brian SCHINZLER, Round Rock, TX (US); Sergio SCHULER, Austin, TX (US); Somasundaram ARUNACHALAM, Raleigh, NC (US)

(21) Appl. No.: 19/034,780

(22) Filed: Jan. 23, 2025

(51) Int. Cl. G06N 5/04

(52) U.S. Cl. CPC G06N 5/04

(57) ABSTRACT

There is provided an apparatus comprising history storage circuitry to store history records. Each history record is configured to support a multi-taken encoding identifying: first and second address identifiers of first and second control flow altering instructions, and a local history of changes in control flow resulting from the second control flow altering instruction. The apparatus is provided with pointer storage circuitry to store a global pointer. The apparatus is provided with prediction circuitry responsive to receipt of an address to identify a local history record for which the address corresponds to the second address identifier, and to provide a prediction based on the global pointer. The prediction circuitry is responsive to receipt of the address to identify a further local history record for which the address corresponds to the first address identifier, and to provide a further prediction based on the global pointer.

### TECHNICAL FIELD

The present invention relates to data processing. More particularly the present invention relates to an apparatus, a system, a chip-containing product, a method, and a computer-readable medium.

### BACKGROUND

Some apparatuses are provided with prediction circuitry responsive to receipt of an instruction address to provide a prediction of changes in control flow associated with that address.

### SUMMARY

According to a first aspect of the present techniques there is provided an apparatus comprising:
history storage circuitry configured to store a plurality of history records, each history record configured to support a multi-taken encoding identifying:
   a first address identifier of a first control flow altering instruction;
   a second address identifier of a second control flow altering instruction, the second control flow altering instruction subsequent to the first control flow altering instruction; and
   a local history of successive changes in control flow resulting from the second control flow altering instruction;
pointer storage circuitry configured to store a global pointer shared between said plurality of local history records, the global pointer indicative of a position in the local history identified in each of the local history records; and

prediction circuitry responsive to receipt of a given instruction address to perform a lookup in the history storage circuitry to identify a local history record for which the given instruction address corresponds to the second address identifier, and when the lookup hits in the history storage circuitry, to provide a prediction of a change in control flow selected from the successive changes in control flow indicated in the local history record based on the global pointer,
wherein the prediction circuitry is responsive to receipt of the given instruction address to perform a further lookup in the history storage circuitry to identify a further local history record for which the given instruction address corresponds to the first address identifier, and when the further lookup hits in the history storage circuitry, to provide a further prediction of a further change in control flow selected from the successive changes in control flow indicated in the further local history record based on the global pointer, the further change in control flow predicted to occur subsequent to the change in control flow.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system of the second aspect, wherein the system is assembled on a further board with at least one other product component.

According to a fourth aspect of the present techniques there is provided a method comprising:
storing, in history storage circuitry, a plurality of history records, each history record configured to support a multi-taken encoding identifying:
   a first address identifier of a first control flow altering instruction;
   a second address identifier of a second control flow altering instruction, the second control flow altering instruction subsequent to the first control flow altering instruction; and
   a local history of successive changes in control flow resulting from the second control flow altering instruction;
storing a global pointer shared between said plurality of local history records, the global pointer indicative of a position in each the local history identified in each of the local history records; and
in response to receipt of a given instruction address, performing a lookup in the history storage circuitry to identify a local history record for which the given instruction address corresponds to the second address identifier, and when the lookup hits in the history storage circuitry, providing a prediction of a change in control flow selected from the successive changes in control flow indicated in the local history record based on the global pointer,
in response to receipt of the given instruction address to perform a further lookup in the history storage circuitry, identifying a further local history record for which the given instruction address corresponds to the first address identifier, and when the further lookup hits in the history storage circuitry, providing a further prediction of a further change in control flow selected from the successive changes in control flow indicated in the further local history record based on the global pointer, the further change in control flow predicted to occur subsequent to the change in control flow.

According to a fifth aspect of the present techniques there is provide a non-transitory computer-readable medium storing computer-readable code for fabrication of an apparatus comprising:
history storage circuitry configured to store a plurality of history records, each history record configured to support a multi-taken encoding identifying:
   a first address identifier of a first control flow altering instruction;
   a second address identifier of a second control flow altering instruction, the second control flow altering instruction subsequent to the first control flow altering instruction; and
   a local history of successive changes in control flow resulting from the second control flow altering instruction;
pointer storage circuitry configured to store a global pointer shared between said plurality of local history records, the global pointer indicative of a position in each the local history identified in each of the local history records; and
prediction circuitry responsive to receipt of a given instruction address to perform a lookup in the history storage circuitry to identify a local history record for which the given instruction address corresponds to the second address identifier, and when the lookup hits in the history storage circuitry, to provide a prediction of a change in control flow selected from the successive changes in control flow indicated in the local history record based on the global pointer,
wherein the prediction circuitry is responsive to receipt of the given instruction address to perform a further lookup in the history storage circuitry to identify a further local history record for which the given instruction address corresponds to the first address identifier, and when the further lookup hits in the history storage circuitry, to provide a further prediction of a further change in control flow selected from the successive changes in control flow indicated in the further local history record based on the global pointer, the further change in control flow predicted to occur subsequent to the change in control flow.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an example multi-taken sequence according to some configurations of the present techniques;

FIG. 4 schematically illustrates an example multi-taken sequence according to some configurations of the present techniques;

FIG. 5 schematically illustrates an apparatus according to some configurations of the present techniques;

FIG. 6 schematically illustrates an apparatus according to some configurations of the present techniques;

FIG. 7 schematically illustrates an apparatus according to some configurations of the present techniques;

FIG. 8 schematically illustrates an apparatus according to some configurations of the present techniques;

FIG. 9 schematically illustrates a sequence of steps according to some configurations of the present techniques;

FIG. 10 schematically illustrates a sequence of steps according to some configurations of the present techniques;

FIG. 11 schematically illustrates a sequence of steps according to some configurations of the present techniques; and

FIG. 12 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising history storage circuitry configured to store a plurality of history records. Each history record is configured to support a multi-taken encoding identifying: a first address identifier of a first control flow altering instruction, a second address identifier of a second control flow altering instruction, the second control flow altering instruction subsequent to the first control flow altering instruction, and a local history of successive changes in control flow resulting from the second control flow altering instruction. The apparatus also comprises pointer storage circuitry configured to store a global pointer shared between said plurality of local history records. The global pointer is indicative of a position in the local history identified in each of the local history records. The apparatus also comprises prediction circuitry responsive to receipt of a given instruction address to perform a lookup in the history storage circuitry to identify a local history record for which the given instruction address corresponds to the second address identifier, and when the lookup hits in the history storage circuitry, to provide a prediction of a change in control flow selected from the successive changes in control flow indicated in the local history record based on the global pointer. The prediction circuitry is responsive to receipt of the given instruction address to perform a further lookup in the history storage circuitry to identify a further local history record for which the given instruction address corresponds to the first address identifier, and when the further lookup hits in the history storage circuitry, to provide a further prediction of a further change in control flow selected from the successive changes in control flow indicated in the further local history record based on the global pointer, the further change in control flow predicted to occur subsequent to the change in control flow.

Prediction of an outcome of control flow altering instructions (e.g., conditional branch instructions or unconditional branch instructions) can involve the following stages:
1. For a given program counter address X identifying a block of one or more instructions, predict an instruction address X1 identifying a first control flow altering instruction (e.g., a conditional branch instruction or a non-conditional branch instruction) in the given block of instructions;
2. Predict the direction for the control flow altering instruction located at address X1, i.e., predict whether the control flow altering instruction will be taken or not taken;
3. If the control flow changing instruction is predicted as taken, then predict the target address, PC=Y, of the predicted control flow changing instruction; and
4. Populate a fetch queue with instruction addresses based on the outcome of predictions 1 to 3 to include instructions, from the block of instructions identified by program counter address X, and update the program counter for the next prediction based on the outcome of the predictions.

Such a prediction cycle enables a fetch queue, configured to identify instructions to be fetched for execution, to be updated to incorporate instruction addresses from one block of instructions per cycle and may be triggered, for example, through an entry in prediction entry storage identifying a predicted outcome for a single branch instruction.

The history storage circuitry of the present invention is configured to support multi-taken entries. A multi-taken entry is configured to identify a first branch instruction comprised in a first instruction block and a second branch instruction comprised in a second instruction block with the second instruction block being the target of the first branch instruction. The multi-taken entry therefore enables a prediction to be made that identifies an outcome of a first branch instruction and a second branch instruction that are expected to occur during program execution and, where a multi-taken entry is identified, and the first branch instruction is predicted to be taken, the control circuitry can populate the fetch queue based on the outcome of both of the first and second branch instructions, thereby increasing the rate at which the fetch queue can be populated.

Whilst multi-taken entries can result in an increased rate at which the fetch queue can be populated, there are additional difficulties to overcome in relation to some use cases of the multi-taken entries. One use case identified by the inventors is the occurrence of a replay event. A replay event may occur, for example, in the event of a pipeline flush. A pipeline flush can be triggered by, for example, a misprediction of a branch direction or another incorrectly predicted event and may be unrelated to any multi-taken predictions associated with instructions being flushed from the pipeline. As pipelines get longer and more complicated the amount of instructions that need to be flushed is increasing. Subsequent to a pipeline flush some of the instructions may be replayed and, consequently, any predictions associated with those instructions may need to be repeated. Rather than repeating each of the predictions that have been previously made, the apparatus is provided with history storage circuitry configured to store local history records identifying changes in control flow associated with control flow altering instructions. For example, a local history record may store an indication of whether a given control flow altering instruction (branch instruction) was taken or not taken for a sequence of preceding occurrences of that branch instruction. The apparatus is also provided pointer storage circuitry configured to store a global pointer. The global pointer is configured to identify a position in the local history records such that, in the event of a flush, the local pointer can be rewound to the point at which the execution of instructions resumes. The global pointer can therefore be used to identify, as a current prediction, a previous prediction recorded in the local history records that was used when that instruction was previously executed (e.g., before the flush occurred). The local history record may therefore be configured to identify, for each global pointer value having a record in the history storage circuitry, an indication of whether a change in control flow altering instruction was encountered for that record and, if so, an indication of the outcome of the control flow altering instruction, i.e., if it was taken or not taken.

The inventors have recognised that the local history records do not provide all the necessary information to determine a previous prediction for a multi-taken entry. The history storage circuitry of the present techniques is therefore configured to support multi-taken entries encoding information relating to a first address identifier of a first control flow altering instruction, a second address identifier of a second control flow altering instruction and a local history of successive changes in control flow resulting from the second control flow altering instruction. During a replay scenario, the prediction circuitry performs two lookups (referred to herein as the lookup and the further lookup) in the history storage circuitry based on a given instruction address. The lookup is performed by comparing the given instruction address against the second address identifier. In other words, the given instruction address is looked up to determine if the given instruction address identifies a branch instruction and, if so, what the outcome of that branch instruction was. In addition, the further lookup is performed to determine if the address identifier is associated with a branch instruction that is a first branch instruction of a multi-taken entry. One or both of the lookups may result in a hit in the history storage circuitry. For example, each of the lookup and the further lookup may hit on different history records. The first lookup may therefore provide a history associated with the branch instruction and the further lookup may result in a history associated with a subsequent branch instruction that forms a two-taken entry with the branch instruction. Alternatively, the first lookup and the second lookup may hit on the same history entry. This may be common, for example, in cases where a short loop is frequently executed with the same branch instruction being repeatedly executed many times in sequence. As a further example, in some cases where the given instruction address is not associated with a multi-taken sequence, the lookup may result in a hit and the further lookup may result in a miss.

Regardless of whether the lookups result in one hit or two hits, for the entries that hit in the history storage circuitry a prediction of the outcome associated with a control flow altering instruction at the given instruction address can be obtained by using the global pointer to identify a particular local history record. The same global pointer may be used to select the prediction of the local history record and the further local history record, regardless of which particular history records are identified. As a result, the history storage circuitry can provide predictions for multi-taken entries reducing the need for more expensive prediction structures to be reused in the event that the pipeline is flushed.

The global pointer value is arranged to indicate a position in the local history records and is defined to be recoverable in the event of a pipeline flush. In some configurations the apparatus comprises: front end circuitry responsive to receipt of an instruction, to associate a tag value to the instruction during processing of the instruction, the tag value corresponding to the global pointer; and misprediction circuitry responsive to a misprediction detection for a given mispredicted instruction, to restore the global pointer in the pointer storage circuitry to a value determined based on the tag value associated with the given mispredicted instruction. The front end circuitry may be provided to associate a supplied instruction supplied for processing by the processing circuitry with a tag value which is determined based on the global pointer stored in the pointer storage circuitry. This association of a supplied instruction with the tag value could be provided in different ways. In one example the instruction may pass down a processing pipeline accompanied by the corresponding tag value, so that the tag value can be identified when the instruction reaches the execute stage of the pipeline. Alternatively, rather than the pointer passing along the pipeline together with the instruction, instead the association between a particular instruction identifier identifying the supplied instruction and the corresponding tagged pointer value could be recorded in a separate storage structure, to reduce the size of the signal paths which convey the instruction down the pipeline itself. The front end circuitry may be one of the relatively early stages of the pipeline, such as a fetch stage or decode stage for example. Misprediction circuitry may be provided which responds to a misprediction detected for a given mispredicted instruction, to restore the global pointer stored in the pointer storage circuitry to a value determined based on the tag value associated with the given mispredicted instruction. The use of a global pointer shared between each of the local history records greatly reduces the cost of the instruction tagging and misprediction recovery compared to an approach where each local history record has its own pointer.

A variety of events could be treated used to trigger the global pointer to be advanced. For example, in some systems an explicit instruction could be provided to instruct that the pointer should be advanced. However, in some configurations the pointer storage circuitry is configured to increment the global pointer in response to a control flow altering instruction causing a backwards change in program flow from a first instruction address to a second instruction address lower than the first instruction address. It may be desirable to reduce the chance that two separate instances of instructions having an instruction address in the same subset are encountered between two successive pointer advance events, as otherwise the observed behaviour for the second of these instructions may overwrite the observed behaviour for the first of the instructions in the history records. In order for two instances of an instruction at the same instruction address to be executed, there must have been a backwards change of program flow between the first instance and the second instance. Hence, by using a detected instance of a backwards change of program flow as the trigger for advancing the pointer, this reduces the likelihood that there will be more than one instance of needing to update a given local history record between successive pointer advance events.

The use of the global pointer allows the prediction circuitry to retrieve the prediction history associated with each of the branch instructions comprised in the two taken entry. In some configurations the history storage circuitry is configured to store, in the encoding of the multi-taken entry, a backwards flow indication identifying whether the first control flow altering instruction caused a backwards change in program flow; and the prediction circuitry is configured, when providing the further prediction, to select the further change in control flow from the successive changes in control flow indicated in the further local history record based on the backwards flow indication. Where the first control flow altering instruction of the multi-taken entry is a backwards taken control flow altering instruction (i.e., a branch instruction that causes control flow to jump from a current instruction address to a previous instruction address occurring before the current instruction address in program order), there may be a change in a value of the global pointer between the first control flow altering instruction and the second control flow altering instruction. Hence, when a lookup is performed in the history storage circuitry, the current value of the global pointer may not correspond to the value of the global pointer when the second branch instruction is encountered. The backwards flow indication indicates that the first control flow altering instruction, if taken, causes such a backwards change in control flow that the prediction circuitry can interpret to select the correct further change in control flow based on the further local history record. As a result, the further change in control flow selected as a result of the further lookup may be selected using a modified global pointer whilst the change in control flow selected as a result of the lookup may be selected based on an unmodified global history pointer.

In some configurations the prediction circuitry is configured, when the backwards flow indication identifies that the first control flow altering instruction caused the backwards change in program flow, to select the further change in control flow based on the global pointer plus one. In general, a multi-taken entry refers to successive control flow altering instructions that do not have any intervening control flow altering instructions between those two control flow altering instructions. As a result, the global pointer may only be modified once between the first control flow altering instruction and the second control flow changing instruction, i.e., as a result of the first control flow altering instruction when the first control flow altering instruction is a backwards taken branch instruction. As a result, the backwards flow indication can be provided in a particularly compact format and could take the form of a single bit to be added to the global pointer when selecting the further change in control flow.

The prediction of control flow altering instructions can be performed on the basis of an identified block of instructions. In some configurations the given instruction address identifies a beginning of a block of instruction addresses; and the apparatus comprises target prediction circuitry, responsive to receipt of the given instruction address, to predict whether the block of instruction addresses comprises one or more control flow altering instructions, the target prediction circuitry configured, when the block of instruction addresses comprises one or more control flow altering instructions, to provide a prediction address of a predicted control flow altering instruction that is predicted to cause a non-sequential change in the control flow as a result of processing instructions in the block of instructions. The target prediction circuitry may be provided as a branch target buffer (BTB) which is looked up based on the given target address and that identifies, as the prediction address within the block of instructions, a specific address of a control flow altering instructions that has been previously identified as occurring within that block of instructions.

Where the BTB lookup is performed at a same time as the lookup and the further lookup, the specific addresses of control flow altering instructions may not be available in the same clock cycle as the given instruction address resulting in potential ambiguity in the address looked up by the prediction circuitry. In some configurations the prediction circuitry is configured to select at least one of the local history record and the further local history record based on the prediction address. For example, based on the given address the prediction circuitry may identify plural entries that result in a hit for one or both of the lookup and the further lookup. Each of the hits may be for a different branch instruction comprised in the same block of instructions, i.e., the block of instructions that is identified by the given instruction address. In order to identify the correct entry from one or both of the lookup and the further lookup, the prediction address output from the target prediction circuitry can be used to disambiguate between the hits. The selection from the local history record and the further local history record may occur during a subsequent clock cycle to each of the lookup and the further lookup. Splitting the lookup and the further lookup so that a portion of the prediction is performed whilst the lookup in the target prediction circuitry, enables a simpler circuit to be provided for the subsequent clock cycle.

In some configurations the target prediction circuitry supports an encoding of a target multi-taken entry identifying the first address identifier, the second address identifier, and a target address of the second control flow altering instruction. The target prediction circuitry may support the encoding using the same physical storage circuitry as is used for single branch instructions (i.e., branch instructions that are not represented using the multi-taken entry). Alternatively, the target prediction circuitry may provide separate storage circuitry for the multi-taken entries with a separate lookup being performed in the storage circuitry configured to store the multi-taken entries. In some configurations the encoding identifies a full first address identifier, the full second address identifier, and the full target address identifier. This approach enables multi-taken entries to be used with no restriction on the relative addresses and target addresses for each of the control flow altering instructions. In alternative configurations the encoding may provide one or more of the first address identifier, the second address identifier, and the target address may be provided as a relative address in relation to another one of the first address identifier, the second address identifier and the target address, resulting in a more compact implementation.

In some configurations the prediction address comprises a unique address of the second control flow altering instruction. The prediction address therefore uniquely defines an address of the second control flow altering instruction and can be provided to the prediction circuitry for selection of the local history record.

In some configurations the first address identifier comprises a subset of address bits of the first control flow altering instruction; and the prediction circuitry is configured to perform an anti-aliasing determination for the further local history record identified from the subset of address bits through comparison of the second address identified in the local history record against the prediction address. In a typical use case, the number of multi-taken sequences of control flow altering instructions that result in an entry in the history storage circuitry will be lower than the number of control flow altering instructions that do not form part of a multi-taken sequence. The inventors have recognised that a more compact formulation of the multi-taken encoding can be provided by including only a subset of address bits of the first control flow altering instruction. The provided subset of address bits may be determined by truncating the address bits of the first control flow altering instruction, for example, to remove one or more most significant address bits or one or more least significant address bits. Alternatively, the provided subset of address bits may be provided by applying a lossy hash function to the address bits. This aliasing means that it is not possible, based only on the first address identifier, to uniquely confirm that the further prediction, identified from one of the history records, corresponds to the correct multi-taken sequence. However, the second address identifier in the local history record can be compared against the prediction address obtained from the target prediction circuitry to confirm the further prediction.

In some configurations each of the plurality of history records comprises a confidence indication indicative of a confidence in the successive changes in control flow. The confidence value is associated with the history record for all of the successive changes in control flow resulting from the second control flow altering instruction. For a given history entry, the confidence may be updated when a predicted outcome resolves, where the prediction is accurate the confidence can be increased and where the prediction is inaccurate the confidence can be decreased. The amount by which the confidence is increased or decreased may be non-symmetrical. For example, the confidence may be gradually incremented in response to an accurate prediction, but may be decremented by a much greater amount in response to an inaccurate prediction. As such a high confidence value may indicate to the prediction circuitry when there is a high likelihood that the prediction or the further prediction will be accurate.

Whilst the prediction circuity may be provided as the only prediction circuitry suitable for predicting changes in control flow, in some configurations the apparatus comprises additional prediction circuitry configured to provide an additional prediction of an outcome of control flow altering instructions based on a global history; and control circuitry configured to select between predictions generated by the additional prediction circuitry and predictions generated by the prediction circuitry based on the confidence indication of the given local history record selected in the prediction. The control circuity may select between the predictions through a comparison of the confidence indication against a threshold or against a confidence indication provided by the additional prediction circuitry. In some configurations the threshold is a static threshold, for example, a preprogramed or hardwired threshold. Alternatively, the threshold may be dynamically modifiable, for example, the threshold may be stored in a software accessible register or may be updated based on a global misprediction rate.

In some configurations the apparatus comprises control circuitry is configured to store a replay indication indicative of whether a replay condition is satisfied and, when the replay indication indicates that the replay condition is not satisfied, to select the additional prediction. The prediction circuitry may therefore only be used when the replay condition is satisfied. Alternatively, in some configurations the prediction may be preferentially selected (i.e., be more likely to be selected) when the replay condition is satisfied and may be less likely to be selected when the replay condition is not satisfied.

The replay condition indicates that one or more instructions are being replayed, e.g., in response to a misprediction. The replay condition may be set or reset in a number of ways. In some configurations the replay condition is satisfied when the control circuitry detects that the given instruction address represents a block of one or more instructions including a replayed instruction to be re-executed following detection of a misprediction associated with an earlier instruction than the replayed instruction. This recognises that when a misprediction occurs, the apparatus may already have executed a number of instructions past that misprediction instruction, and while any instructions which depend on the mispredicted instruction may be incorrect, the outcomes of some independent instructions may be correct regardless of the misprediction. Hence, when execution is wound back to the point of the misprediction and subsequent instructions are re-executed, there may be some replayed instructions which are at a point of program flow where program flow has already converged again (if it had separated based on the prediction), so that the same replayed instruction is executed again and may still have the same outcome as it did when the replayed instruction was executed the first time following the mispredicted instruction. It is recognised that at the point when the replayed instruction is encountered again, the observed instruction behaviour seen for that instruction the first time may still be present in the local history for the corresponding subset of instruction addresses, and so can be used to directly determine the predicted instruction behaviour for the re-execution of the replayed instruction. The prediction based on the actually observed instruction behaviour for the first instance of executing the replayed instruction may often be more accurate than a prediction of the outcome of the replayed instruction based on the at least one prediction table which may be based on earlier instances of encountering the replayed instruction. Hence, by determining the predicted instruction behaviour directly based on the selected portion of the selected local history record when the replay condition is satisfied for the given instruction address, this can provide greater prediction accuracy. For example, the prediction circuitry may, following a misprediction, maintain a record of instruction addresses of executed instructions which were independent of the mispredicted instruction, so that the replayed instruction satisfying a replay condition can be identified if one of those instructions is executed again.

Whilst it will be readily apparent to the person of ordinary skill in the art that the additional prediction circuitry can be provided by any type of branch prediction circuitry, in some configurations the apparatus comprises further prediction circuitry configured to provide the subsequent prediction based on a global history of outcomes of branch instructions. In some configurations the additional prediction circuitry is tagged geometric history length (TAGE) prediction circuitry configured to predict whether conditional control flow altering instructions will be taken or not based on a plurality of TAGE tables tagged by a range of lengths of execution history. The TAGE prediction circuitry implements a form of branch direction predictor referred to as a TAGE branch predictor. The TAGE prediction circuitry may be provided as a branch direction predictor to predict whether conditional control flow changing instructions will be taken or not taken. The TAGE prediction circuitry comprises a plurality of TAGE tables, each tagged by an indication of the execution history leading to the control flow changing instruction, with those indications representing a different length of execution history for the different TAGE tables. In order to track in which of those tables a hit needs to be detected for a given control flow changing instruction for a prediction to be made on the basis of the information stored in the TAGE tables, the prediction circuitry maintains a TAGE class value. For control flow changing instructions that are expected to be predicted with a high degree of confidence, the TAGE class value will be small such that only a small number of the TAGE tables (corresponding to shorter execution history length) need to have a hit detected for a prediction. Conversely, control flow changing instructions for which the direction is less certain will have a higher TAGE class value indicating that a hit needs to be detected in more TAGE tables (and so execution history having a longer length needs to match) for the prediction to be made. In some configurations the execution history is a global execution history common to all branch instructions. For example, the global history may comprise a vector having elements indicating, for each of a plurality of previous predictions, an indication of whether those predictions were taken or not-taken.

Particular configurations will now be described with reference to the figures.

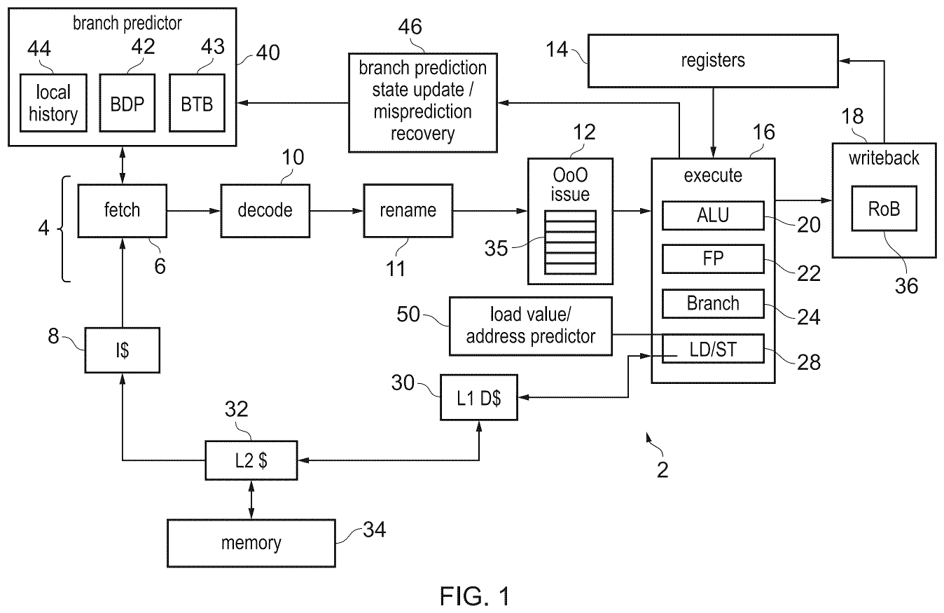

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; a register renaming stage 11 for mapping architectural registers specified by program instructions or micro-operations to physical register specifiers identifying physical registers in a register file 14; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

The processor shown in FIG. 1 is an out-of-order processor where the pipeline 4 includes a number of features supporting out-of-order processing. This includes the issue stage 12 having an issue queue 35 for queuing instructions and issue control circuitry which is able to issue a given instruction for execution if its operands are ready, even if an earlier instruction in program order has not issued yet. Also the writeback stage 18 may include a reorder buffer (ROB) 36 which tracks the execution and the commitment of different instructions in the program order, so that a given instruction can be committed once any earlier instructions in program order have themselves be committed. Also, the register renaming stage 11 helps to support out of order processing by remapping architectural register specifiers specifying the instructions decoded by the decode stage 10 to physical register specifiers identifying physical registers 14 provided in hardware. The instruction encoding may only have space for a register specifiers of a certain limited number of bits which may restrict the number of architectural registers supported to a relatively low number such as 16 or 32. This may cause register pressure, where after a certain number of instructions have been processed a later instruction which independent of an earlier instruction which references a particular register needs to reuse that register for storing different data values. In an in-order processor, that later instruction would need to wait until the earlier reference to the same register has completed before it can proceed, but these register dependencies caused by insufficient number of architectural registers can be avoided in an out-of-order processor by remapping the references to the same destination register in different instructions to different physical registers within the register file 14, which may comprise a greater number of physical registers than the number of architectural registers supported in the instruction encoding. This can allow a later instruction which writes to a particular architectural register to be executed while an earlier instruction which writes to the same architectural register is stalled, because those register references are mapped to different physical registers in the register file 14. It will be appreciated that other features may support out of order processing.

As shown in FIG. 1, the apparatus 2 has a number of prediction mechanisms for predicting instruction behaviour for instructions at particular instruction addresses. For example, these prediction mechanisms may include a branch predictor 40 and a load value or load address predictor 50. It is not essential for processors to have both forms of predictor. The load value or load address predictor is provided for predicting data values to be loaded in response to load instructions executed by the load/store unit 28 and/or predicting load addresses from which the data values are to be loaded before the operands for calculating the load addresses have been determined. For example, the load value prediction may record previously seen values loaded from a particular address, and may predict that on subsequent instances of loading from that address the value is expected to be the same. Also, the load address predictor may track history information which records observed stride patterns of address accesses (where the addresses of successive loads differ by a constant offset) and then use that observed stride pattern to predict the address of a future load instructions by continuing to add offsets to the latest seen address at intervals of the detected stride.

Also, the branch predictor 40 may be provided for predicting outcomes of branch instructions (otherwise referred to as control flow altering instructions), which are instructions which can cause a non-sequential change of program flow. Branches may be performed conditionally, so that they may not always be taken. The branch predictor is looked up based on addresses of instructions provided by the fetch stage 6, and provides a prediction of whether those instruction addresses are predicted to correspond to branch instructions. For any predicted branch instructions, the branch predictor provides a prediction of their branch properties such as a branch type, branch target address and branch direction (branch direction is also known as predicted branch outcome, and indicates whether the branch is predicted to be taken or not taken). The branch predictor 40 includes a branch target buffer (BTB) 43 for predicting properties of the branches other than branch direction, and a branch direction predictor (BDP) 42 for predicting the not taken/taken outcome of a branch (branch direction). It will be appreciated that the branch predictor could also include other prediction structures, such as a call-return stack for predicting return addresses for function calls, a loop direction predictor for predicting when a loop controlling instruction will terminate a loop, or other specialised types of branch prediction structures for predicting behaviour of branches in specific scenarios. In general, the BTB may act as a cache correlating particular instruction addresses with sets of one or more branch properties such as branch type or the branch target address (the address predicted to be executed next after the branch if the branch is taken), and may also provide a prediction of whether a given instruction address is expected to correspond to a branch at all.

The branch direction predictor 42 may be based on a variety of different prediction techniques, e.g. a TAGE predictor or a perceptron predictor, which includes prediction tables which track prediction state used to determine whether, if a given instruction address is expected to correspond to a block of instructions including a branch, whether that branch is predicted to be taken or not taken. The BDP 42 may base its prediction on local history records tracked in local history storage circuitry 44. The local history records will be discussed in more detail below, but in general they provide tracking of sequences of observed instruction behaviour for instructions whose instruction addresses map onto a particular subset of instruction addresses, with a number of separate local history records being provided for different subsets of instruction addresses. This can be used for indexing into the prediction tables of the BDP 42 or in some cases to provide a direct prediction of the predicted branch behaviour.

The apparatus 2 may have branch prediction state updating circuitry and misprediction recovery circuitry 46, which updates state information within the branch predictor 40 based on observed instruction behaviour seen at the execute stage 16 for branch instructions executed by the branch unit 24. When a branch instruction is executed and the observed behaviour for the branch matches the prediction made by the branch predictor 40 (both in terms of whether the branch is taken or not and in terms of other properties such as branch target address) then the branch prediction state updating circuitry 46 may update prediction state within the BDP 42 or the BTB 43 to reinforce the prediction that was made so as to make it more confident in that prediction when that address is seen again later. Alternatively, if there was no previous prediction state information available for a given branch then when that branch is executed at the execute stage 16, its actual outcome is used to update the prediction state information. Similarly, the local history storage 44 may be updated based on an observed branch outcome for a given branch.

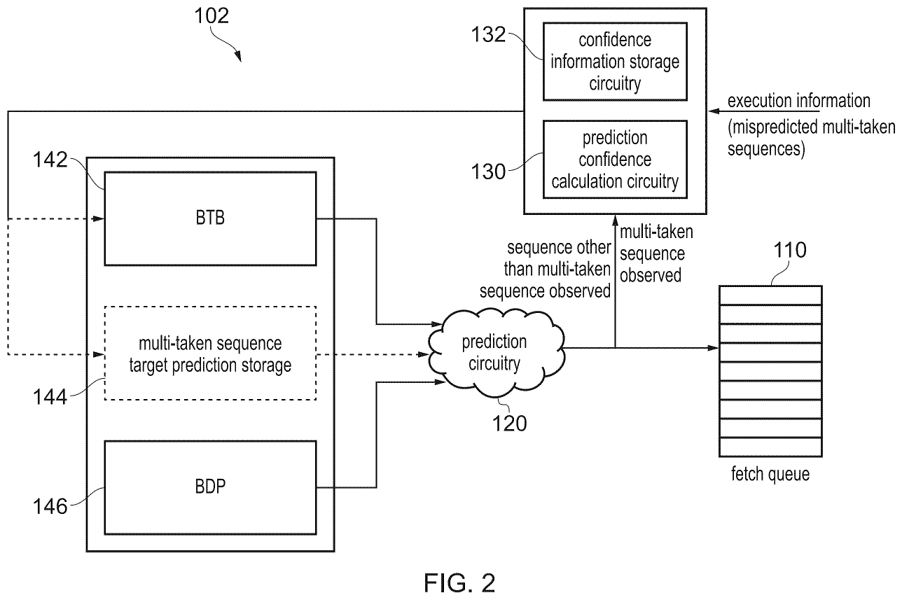

FIG. 2 is a schematic illustrating further detail of an apparatus 102 in accordance with some configurations of the present techniques. The apparatus 102 implements branch prediction to populate a fetch queue 110 (also referred to as a prediction address queue) with instruction addresses that are identify instructions to be fetched for execution by one or more execution units of the apparatus 102. Those addresses can be routed to an instruction cache (not shown) that retrieves the instructions at the identified addresses (if a hit is detected in the instruction cache for an input address, then the instruction can be output directly from the instruction cache, whereas otherwise the instruction can be requested from a lower level of a memory hierarchy forming the memory system and, when retrieved, can be output from the instruction cache). The fetched instructions are then forwarded to an instruction decoder where they are decoded in order to produce control signals used to control the operation of the execution units so as to implement the operations required by those instructions.

The apparatus 102 may be arranged during each prediction iteration to consider a predict block of instructions, where the predict block comprises a plurality of sequential instructions within the memory address space. The predict block may for example be identified by a start address identifying the first instruction address within the predict block, and the size of the predict block will typically be predetermined. For example, a 32 byte predict block may be considered in each prediction iteration, and in one particular implementation each instruction may have an instruction address formed of 4 bytes, such that each predict block represents eight instructions at sequential addresses in memory.

Each predict block predicted by the apparatus 102 is added into the fetch queue 110, whilst also being provided to various branch prediction mechanisms within the apparatus 102. The aim of the apparatus 102 is to predict whether any instructions identified by the predict block are control flow changing instructions that are predicted as taken. In the event that the predict block includes one or more of such instructions, then the location of the first control flow changing instruction that is predicted as taken is identified, and the target address of that control flow changing instruction is used to identify the start address for the next predict block. If no such control flow changing instructions are identified within the predict block, then the start address for the next predict block is merely the sequential address following the last address of the current predict block. When the branch predictor 110 predicts that a predict block does include a control flow changing instruction that is predicted as taken, then the position of that control flow changing instruction is used to modify the content of the predict block as added into the fetch queue 110. For example, if it is determined that the fourth instruction in the sequence of eight identified by a predict block is predicted as taken, then the final four instructions will be discarded from the sequence of instructions identified within the fetch queue 110, so that those later instructions are not fetched for execution by the execution circuitry, and instead the next instruction fetched after the fourth instruction in that predict block will be the instruction at the predicted target address for the control flow changing instruction (i.e. the first instruction in the next predict block).

The apparatus 102 can include a number of branch prediction components. As shown in FIG. 2, a branch direction predictor (BDP) 146 can be used for seeking to predict whether a conditional control flow changing instruction will be taken or not taken. If a control flow changing instruction is not taken, then the next instruction to be executed will be the instruction immediately following that instruction flow changing instruction in the instruction address space. However, if the instruction flow changing instruction is predicted as taken, then a determination of the target address for that instruction is required, as the next instruction that will be predicted to be executed will be the instruction at that target address.

To assist in the prediction of target addresses, one or more branch target buffer (BTB) structures may be provided. For example, as illustrated in FIG. 2, a BTB 142 is provided for making a prediction of the target address of a control flow changing instruction that is predicted as taken. Hence, for a control flow changing instruction that is predicted as taken, the BTB 142 can be used to assist in the determination of a target address for that control flow changing instruction. In particular, an entry may be provided for that control flow changing instruction, and may include information that is used to determine a predicted target address. That predicted target address may be encoded directly within the entry of the BTB, or alternatively a further target prediction structure may be referenced in order to predict the target address. For example, if the BTB 142 identifies that the branch instruction is a function return instruction, then the target address itself may not be identified within the BTB entry, but instead a return stack structure will be referred to in order to obtain the predicted target address.

The throughput of the apparatus 102 can effectively represent a bottleneck within the system. In particular, the fetch queue 110 may be able to receive multiple blocks of instructions in a single cycle, but the apparatus 102 itself may only be able to receive and process a single block of instructions in one cycle. In accordance with the techniques described herein, a mechanism is provided that enables multi-taken sequences to be populated in target prediction storage (either the BTB 142 or separately provided multi-taken sequence target prediction storage 144) to enable two blocks of instructions to be added into the fetch queue 110 in a single cycle.

To support this behaviour and so as to maintain the accuracy of prediction, prediction confidence calculation circuitry 130 is provided to monitor confidence levels associated with a plurality of multi-taken sequences in order to control which multi-taken sequences predictions should be allowed to be made.

In accordance with the techniques described herein, the prediction confidence calculation circuitry 130 maintains confidence information stored in confidence information storage circuitry 132 to identify multi-taken sequences and maintain an associated confidence level associated with such sequences. Based on execution information from execution circuitry (which may include instances of misprediction where a multi-taken sequence was incorrectly predicted, and observed sequences of instructions where multi-taken sequences are either taken or not taken), the prediction confidence calculation circuitry 130 updates the confidence information in the confidence information storage circuitry 132 to represent any resulting changes in the confidence levels.

Based on the confidence levels for the multi-taken sequences, the prediction confidence circuitry populates and invalidates entries in the target prediction storage for multi-taken sequences (which may be implemented as dedicated multi-taken sequence target prediction storage 144 or may be implemented as part of the BTB 142).

Prediction circuitry 120 is provided to make determinations, based on the prediction components (including the BTB 142, the multi-taken sequence target prediction storage 144 if provided, and the branch direction predictor 146) about which predictions should be made and so how to populate the fetch queue 110. Hence, by altering which indications of multi-taken sequences are stored in the target prediction storage 142, 144, the prediction confidence calculation circuitry is able to control whether the prediction circuitry 120 is allowed to predict particular multi-taken sequences.

In this way, the prediction confidence calculation circuitry 130 is able to allow the prediction circuitry 120 to make predictions of multi-taken sequences, even when it is not known for certain whether the multi-taken sequence will turn out to be executed as predicted, whilst maintaining a high level of accuracy so as to reduce the incidence of mispredictions.

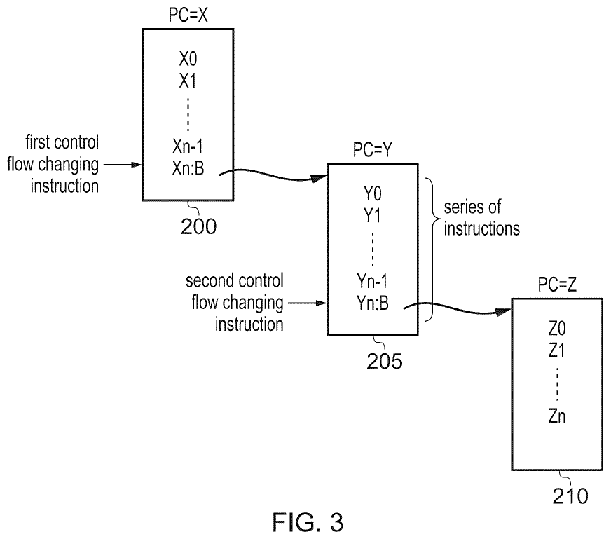

FIG. 3 schematically illustrates an example multi-taken sequence of the form that may be predicted using the apparatus 102 of FIG. 2. In this instance, a first predict block X 200 is assumed to contain a control flow changing instruction, having address Xn, that is predicted as taken and that results in the identification of a target address identifying the next predict block Y 205. This second predict block Y terminates with a control flow changing instruction that branches to the predict block Z 210. In such situations, it has been found possible to create an entry within target prediction circuitry 142, 144 that identifies as a first control flow changing instruction the branch instruction within the predict block X 200, along with an indication of the associated target address Y0, and in addition captures sufficient information about the predict block Y 205 and the resulting target address Z0 to enable both the predict blocks Y 205 and Z 210 to be added directly into the fetch queue, but with the next prediction iteration starting with the predict block Z 210.

Control flow changing instructions can be categorised into two types, namely those exhibiting dynamic behaviour and those exhibiting static behaviour. Dynamic behaviour instructions change their behaviour dependent on the status of the processor executing those instructions. Hence, dynamic control flow changing instructions include any form of conditional branch instruction, since a direction prediction is required in order to determine whether the branch will be taken or not taken, and typically an assessment of certain condition flags of the processor is required in order to determine whether the control flow changing instruction will be taken or not. As another example of a dynamic behaviour branch instruction, polymorphic indirect branches will also be considered to exhibit dynamic behaviour, since typically the target address will depend on the contents of at least one general purpose register, and those contents will vary between instances where that indirect branch instruction is executed.

Static behaviour branch instructions are then the remaining branch types. Hence, any unconditional direct control flow changing instruction will be considered to exhibit static behaviour, since it will always be taken, and the target address can be determined directly from the branch instruction itself, and hence does not vary each time the unconditional direct branch instruction is executed. Also, for the purposes of the techniques described herein, unconditional function return instructions can be considered to exhibit static behaviour since, despite the fact that the target address can vary (for example due to different function call instructions being associated with the same function return instruction), the target address is predictable in that it can be obtained from a return stack structure.

In some configurations, multi-taken sequences exhibiting static behaviour, (i.e., for which the second control flow changing instruction has static behaviour and none of the series of instructions occurring earlier in the predict block Y 205 than the second control flow changing instruction Yn are control flow changing instructions) are predicted. This may be done to ensure accuracy of prediction since if the first control flow changing instruction is correctly predicted (e.g., using existing prediction structures) it will be known that the multi-taken sequence will proceed as predicted.

In addition, in some configurations, as well as predicting multi-taken sequences that exhibit static behaviour, multi-taken sequences that exhibit dynamic behaviour can be predicted. Thus, multi-taken sequences having as their second control flow changing instruction a conditional control flow changing instruction and multi-taken sequences having additional control flow changing instructions in the series of instructions can be predicted. This can therefore increase the rate at which predictions can be made, with the prediction confidence calculation circuitry 130 operating to ensure that a desired level of prediction accuracy is maintained.

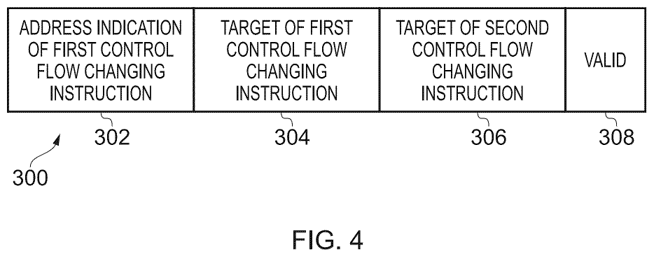

FIG. 4 illustrates a target prediction entry 300 used to store an indication of a multi-taken sequence for reference by the prediction circuitry 120. As illustrated, the entry comprises an address indication of a first control flow changing instruction to identify the address of either a first control flow changing instruction or a predict block containing such a first control flow changing instruction. The entry 300 also identifies a target of the first control flow changing instruction 304 and a target of the second control flow changing instruction 306. Based on this information, the prediction circuitry 120 can cause the predict blocks containing the targets of the first and second control flow changing instructions respectively to be identified in the fetch queue 110. The target prediction entry 300 also comprises a valid indicator 308 to indicate whether the target prediction entry 300 is a valid entry upon which a prediction can be based. This may be implemented as a single bit having a first value (e.g., zero) to indicate that the entry is valid and can be used by the prediction circuitry 20 to make predictions and a second value (e.g., one) to indicate that the entry is invalid and so should not be used as the basis of predictions. Thus, to prevent the multi-taken sequence being predicted by the prediction circuitry 120, the prediction confidence calculation circuitry 130 can set the valid indicator to the second value, thereby preventing the multi-taken sequence associated with the entry 300 being predicted.

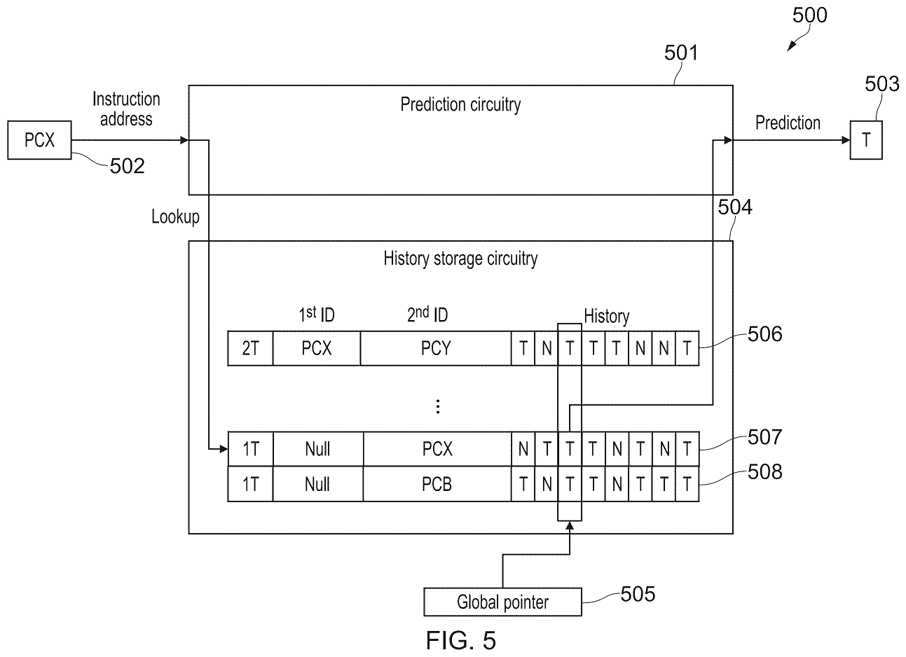

FIG. 5 schematically illustrates an apparatus 500 according to some configurations of the present techniques. The apparatus 500 is provided with history storage circuitry 504 and prediction circuitry 501. The history storage circuitry is configured to store a plurality of history records 506, 507, 508. The history storage circuitry 504 is configured to support an encoding of prediction entries 507, 508 identifying a second address identifier (2^{nd} ID) of a second control flow altering instruction and a history of outcomes of the control flow altering instruction (whilst the terminology “second” address identifier and “second” control flow altering instruction is used in reference to the prediction entries that do not encode a multi-taken entry, it will be readily apparent to the person of ordinary skill in the art that only one instruction address identifier is recorded in these entries and that the term “second” is used for comparison against the multi-taken encoding and consistency when referencing this field in the history storage circuitry 504). The history storage circuitry 504 is configured to support a multi-taken encoding 506 identifying a first address identifier (1^{st} ID) of a first control flow altering instruction and a second address identifier (2^{nd} ID) of a second control flow altering instruction along with a local history of outcomes of the second control flow altering instruction.

The apparatus 500 is also provided with pointer storage circuitry 505 configured to store a global pointer that is shared between the plurality of history records 506, 507, 508 that is indicative of a position in the local history identified in each of the local history records.

The prediction circuitry 501 is configured to predict the outcome of branch instructions that may be observed during a sequence of instructions to be executed by processing circuitry. In particular, the prediction circuitry 501 is responsive to receipt of a given instruction address to determine whether the given instruction address corresponds to a control flow altering instruction and to predict an outcome of the control flow instruction. In the illustrated configuration the prediction circuitry 501 receives an indication of an instruction address 502 indicating a program counter value PCX. The prediction circuitry 501 triggers a lookup to be performed in the history storage circuitry 504. The lookup comprises comparing the instruction address 502 against the second address identifier of each of the history records 506, 507, 508 to identify one or more history records for which the second address identifier matches the instruction address 502. In the illustrated configuration the instruction address 502 matches against the second address identifier recorded in the history record 507. It is noted that, whilst the history record 506, encoded using the multi-taken encoding, also identifies the program counter value PCX as indicated in the instruction address 502, the program counter value PCX is not recorded as the second address identifier and, hence, there is not a hit on the history record 506 for the lookup. Once the history record 507 is identified based on the lookup, the prediction 503 is determined based on the global pointer stored in the pointer storage circuitry 505. The global pointer identifies a position in the history file and enables an outcome (i.e, taken or not taken) of the control flow altering instruction at PCX to be read from the history record. In the illustrated configuration the outcome of the control flow altering instruction at PCX is T (taken) and this outcome is output as a prediction 503 by the prediction circuitry 501.

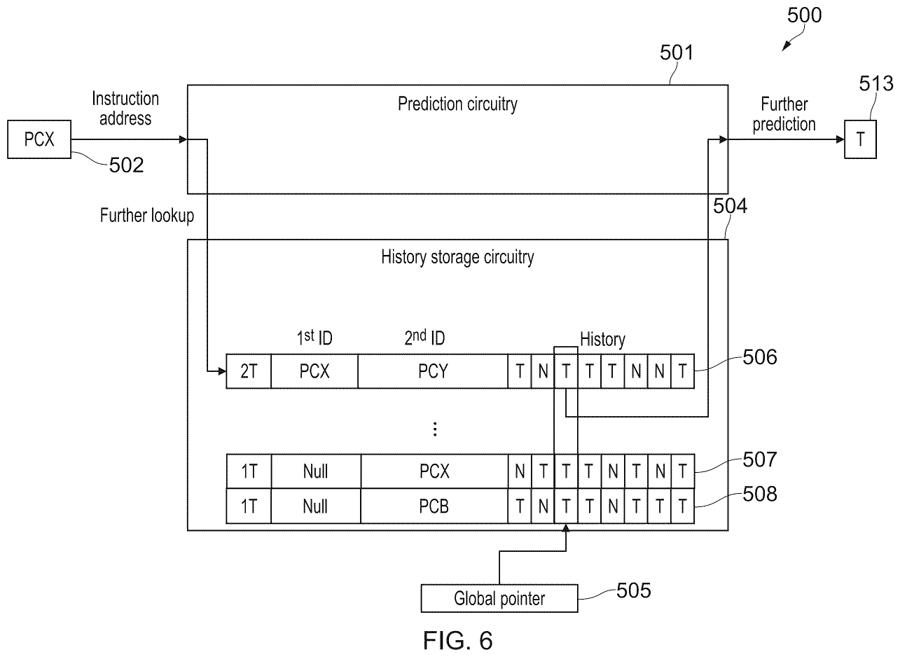

In addition to performing the lookup in response to the instruction address 502, the prediction circuitry 501 performs a further lookup as illustrated in FIG. 6. The further lookup is performed to identify whether the instruction address 502 is associated with multi-taken sequence of control flow altering instructions and, if so, to generate a further prediction 513 identifying an outcome of a second control flow altering instruction in that sequence. In other words, the lookup illustrated in FIG. 5, is provided to determine an outcome of a given control flow altering instruction and the further lookup, illustrated in FIG. 6, is provided to identify an outcome of a control flow altering instruction that is predicted to occur subsequent to the given control flow altering instruction. The further lookup is performed to compare the instruction address 502 against the first instruction identifier recorded in the multi-taken encoded entries, for example the multi-taken encoded entry 506. In the illustrated configuration, the further lookup results in a hit on the multi-taken encoded entry 506. Once the history record 506 is identified based on the further lookup, the further prediction 513 is determined based on the global pointer stored in the pointer storage circuitry 505. The global pointer identifies a position in the history file and enables an outcome (i.e., taken or not taken) of the control flow altering instruction at PCY (i.e., subsequent to the control flow altering instruction at PCX) to be read from the history file. In the illustrated configuration the outcome of the control flow altering instruction at PCY is T (taken) and this outcome is output as the further prediction 513 by the prediction circuitry 501. In this way, the prediction circuitry 501 is able to output a prediction 503 and a further prediction 513 for control flow altering instructions at PCX and PCY respectively in response to receipt of instruction address 502 identifying PCX.

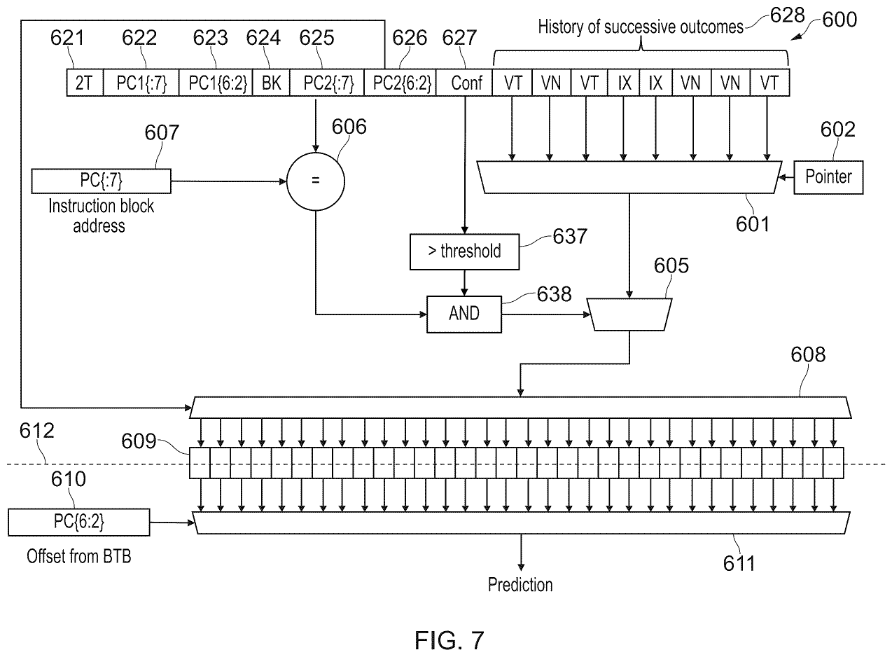

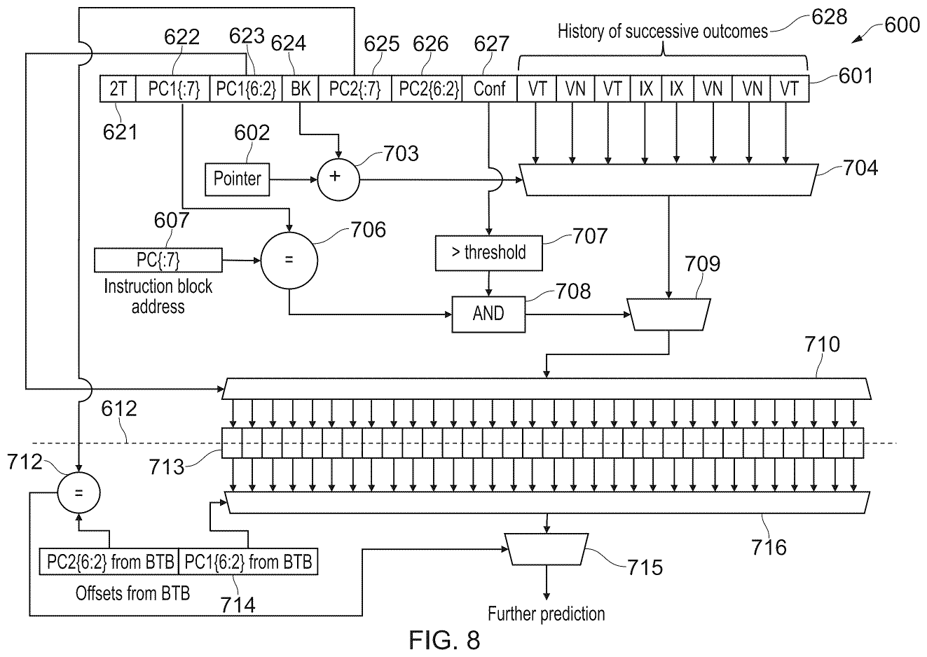

FIGS. 7 and 8 schematically illustrate further details of the lookup and the further lookup respectively. In the illustrated configuration the dashed line 612 identifies a stage boundary (cycle boundary) with steps illustrated above the dashed line 612 being performed in one stage (one cycle) and the steps illustrated below the dashed line 612 being performed in a subsequent stage (subsequent cycle). Elements spanning the dashed line 612 (i.e., the elements of the 32-element vector 612) identify data that is passed from one stage to the subsequent stage.

The lookup and the further lookup are performed in response to receipt of an instruction block address 607 which identifies a block of instructions. In the illustrated configuration, the block of instructions is identified through the most significant portion of the program counter value, PC{: 7} which includes the most significant bits of the program counter address down to bit 7. For instructions that take 4 bytes, the block of instructions therefore identifies 32 instructions. The lookup comprises performing a comparison of the instruction block address 607 against second instruction identifiers included in a plurality of history entries. FIG. 7 schematically illustrates a history entry 600 which comprises a first field 621 identifying whether the history entry 600 is a multi-taken entry or a single taken entry, a first address block identifier 622 identifying a first block of instructions, a first address offset 623 identifying an offset of a first control flow altering instruction within the first block of instructions, a backwards taken indicator 624 identifying whether the first branch instruction is a branch instruction that, if taken, would result in a backwards change in control flow, a second instruction identifier 625 identifying a second block of instructions, a second instruction offset 626 identifying an offset of a second control flow altering instruction within the second block of instructions, and a history of successive outcomes 628. The history of successive outcomes 628 is provided as a vector of entries with each entry in the vector of entries identifying whether that entry is valid (i.e., for that position in the history, is there a record of the second branch instruction being executed) and an indication of a branch direction (i.e., for that position in the history, if there is a valid record of the second branch instruction being executed, what was the outcome of that branch instruction).

The lookup and the further lookup are also performed with reference to a global pointer 602 which is provided to identify a position in the history of successive outcomes 628. The global pointer 602 is indicative of a number of backwards taken branches and, hence, for any two instances of a same control flow altering instruction instruction having a same address, the global pointer 602 will take a different value because, in order for the same control flow altering instruction having the same address to be encountered twice in a flow of instruction addresses that proceeds sequentially, a backwards taken control flow altering instruction will have been taken to cause the program counter value to be rewound to point to an address that precedes the address of the backwards taken control flow altering instruction. During replay, i.e., subsequent to a flush that causes the processing of instructions to be rewound and, hence, causes the global pointer 602 to be decreased, the global pointer 602 can be used to index into the history of successive outcomes 628 in order to determine an outcome of control flow altering instructions (e.g., as identified in the history record 600) that occurred, or was predicted, when those control flow altering instructions were encountered prior to the flush.

The first lookup is performed to identify whether, for the current block of instructions identified by the instruction block address 607, a control flow altering instruction was previously observed in a block of instructions identified by the instruction block address 607 for a given value of the global pointer 602. The instruction block address 607 is compared against the second instruction block identifier 625 which comprises a most significant bit of a program counter value for a previously observed second control flow altering instruction, PC2{:7}. The bits of the second instruction block identifier 625, PC2{:7} and the instruction block address 607, PC{:7}, are each passed to comparison circuitry 606 which determines if there is a match.

In addition, the history of successive outcomes 628 is passed to de-multiplexing circuitry 601 which also receives a value of the global pointer 602. The value of the global pointer 602 is used by the de-multiplexing circuitry 601 to select one of the outcomes from the history of successive outcomes 628. The selected output is then passed to switch circuitry 605. The switch circuitry 605 is operated based on whether the comparison circuitry 606 identified that the instruction block address 607 matched the second instruction block identifier 625, and a confirmation that a prediction confidence, i.e., a confidence in the history entry, is sufficiently high. The confidence value 627 is provided to threshold circuitry 637 which determines whether the confidence is greater than a threshold. The threshold may be predefined or dynamically modified, for example, based on a confidence of one or more other prediction structures, or based on a variable threshold value stored in a register. If the confidence is greater than a threshold, then the threshold circuitry 637 outputs a logical one to AND circuitry 638 which also receives an indication of the result of the comparison performed by the comparison circuitry 606. When the outcome of the comparison circuitry 606 indicates a match and the confidence is above the threshold, then the AND circuitry 638 outputs an indication of the match to switch circuitry 605 which forwards the selected outcome to multiplexing circuitry 608. In the event that either the comparison circuitry does not indicate a match or the confidence is not above the threshold, then the AND circuitry 638 triggers the switch circuitry 605 to output an invalid indication as the selected outcome.

The multiplexing circuitry 608 selects an output based on the second instruction offset 626 which identifies the address of the second control flow altering instruction within the second block of instructions. The second offset stores bits PC2{6:2}, which identify a particular instruction address within the second block of instructions. The multiplexing circuitry outputs the selected outcome to a 32-element vector 609 that stores potential outcomes for each instruction within the block of instructions. These steps are performed for each history record in the history record storage and multiple matches may be identified, for example, where there are multiple control flow altering instructions within a block of instructions. As a result, multiple elements within the 32-element vector 609 may comprise a prediction for a previously observed instruction address within the block of instructions identified by the instruction block address 607.

At the same time (e.g., within a same cycle), a branch target lookup is performed in the branch target buffer based on the instruction block address 607 (not illustrated). The lookup in the branch target buffer enables an offset prediction 610 associated with a sequentially first taken branch instruction within the block of instructions to be identified. The offset prediction 610 is passed to de-multiplexing circuitry 611 and is used to select the prediction from the 32-element vector. The prediction includes an indication of whether the prediction is valid and, if so, whether the control flow altering instruction identified at the offset 610 is taken or not taken. The prediction is then output as a prediction for whether the control flow altering instruction is taken or not taken.

FIG. 8 schematically illustrates the further lookup that is performed at the same time (e.g., in parallel with or during a same cycle as) the lookup based on the same history records. The purpose of the further lookup is to identify whether, prior to the replay event, the instruction block identified by the instruction block address 607 included any control flow altering instructions that were identified as a first control flow altering instruction in a multi-taken sequence and, if so, to identify the predicted outcome of the second control flow altering instruction in that multi-taken sequence.

In the further lookup, it is first determined whether the multi-taken identifier 621 is set. If so, then the instruction block address and the first instruction block identifier 622 are passed (routed) to comparison circuitry 706 which determines if there is a match. In the illustrated configuration, the full instruction block address 607 and a corresponding set of bits of the first instruction block identifier 622 are compared. However, it will be readily apparent that a subset of bits of the instruction block address 607 could be used and a corresponding subset of bits of the first instruction block identifier 622 could be stored. As a further alternative, a lossy hash of the second instruction block identifier 622 could be stored and the instruction block address 607 could first be passed through hash circuitry before being passed to comparison circuitry 706.

In addition, the global pointer 602 and the backwards taken identifier 624 are passed to addition circuitry 703. Because the circuit is identifying the predicted outcome of the second control flow altering instruction in a multi-taken sequence, the global pointer 602 provided in relation to first instruction blocks that match the instruction block address 607 may not be correct once execution progresses to the second control flow altering instruction. In particular, if the first control flow altering instruction is identified as a backwards taken control flow altering instruction, then the global pointer 602 will be out by one with respect to the value of the global pointer when the second control flow altering instruction was encountered. This is corrected using the backwards taken indication 624 which identifies if the first control flow altering instruction was a backwards taken control flow altering instruction. If it was, then the global pointer 602 is incremented by the addition circuitry 703. Otherwise, the global pointer 602 is not incremented by the addition circuitry 703. The output of the addition circuitry 703 is passed to the de-multiplexing circuitry 704 which selects an outcome from the history of successive outcomes 628. The selected outcome is passed to the switch circuitry 709.

The switch circuitry 709 is operated based on whether the comparison circuitry 706 identified that the instruction block address 607 matched the first instruction block identifier 621, and a confirmation that a prediction confidence is sufficiently high. The confidence value 627 is provided to threshold circuitry 707 which determines whether the confidence is greater than a threshold. The threshold may be predefined or dynamically modified, for example, based on a confidence of one or more other prediction structures, or based on a variable threshold value stored in a register. The threshold for the lookup may be the same as the threshold for the further lookup or may take a different value. If the confidence is greater than the threshold, then the threshold circuitry 707 outputs a logical one to AND circuitry 708 which also receives an indication of the result of the comparison performed by the comparison circuitry 706. When the outcome of the comparison circuitry 706 indicates a match and the confidence is above a threshold, then the AND circuitry 708 outputs an indication of the match to switch circuitry 709 which forwards the selected outcome to multiplexing circuitry 710. In the event that either the comparison circuitry 706 does not indicate a match or the confidence is not above the threshold, then the AND circuitry triggers 708 the switch circuitry to output an invalid indication as the selected outcome.

As in the case of the lookup, the selected outcome for the further lookup is routed to an entry of the 32-element vector 713 by the multiplexing circuitry 710 based on the first offset 623 which uniquely identifies the first control flow altering instruction within the first block of instructions. These steps are performed for each history record in the history record storage and multiple matches may be identified, for example, where there are multiple control flow altering instructions identified as multi-taken entries within a block of instructions. As a result, multiple elements within the 32-element vector 710 may comprise a prediction for a previously observed instruction address within the block of instructions identified by the instruction block address 607.

At the same time (e.g., within a same cycle), a branch target lookup is performed in the branch target buffer based on the instruction block address 607 (not illustrated). The lookup in the branch target buffer enables an offset prediction 714 associated with a sequentially first taken branch instruction within the block of instructions to be identified along with a determination of whether the branch instruction is predicted to be a first branch instruction of a multi-taken sequence, and if so, a prediction of an address of a second branch instruction within that multi-taken sequence. The offset prediction 714 comprises a prediction of the offset of the first branch instruction and a prediction of the offset of the second branch instruction. The prediction of the first offset from the offset prediction 714 is passed to de-multiplexing circuitry 716 and is used to select the prediction from the 32-element vector. The prediction includes an indication of whether the prediction is valid and, if so, whether the control flow altering instruction identified at the predicted first offset is taken or not taken. The prediction is then passed to switch circuitry 715.

In addition, the second offset 625 identified in the history record 600 is compared against the prediction of the second offset from the offset prediction 714 using comparison circuitry 712 to confirm that the predicted offset from the BTB corresponds to the multi-taken sequence identified in the prediction history. The output of the comparison circuitry 712 is passed to the switch circuitry 715 and, when the second offset 625 identified in the history record 600 matches the prediction of the second offset from the offset prediction 714, the prediction is output as a further prediction for whether the second control flow altering instruction is taken or not taken.

For a given instruction block address, the lookup (illustrated in FIG. 7) can be used to identify a predicted outcome of a first branch instruction encountered in that block, and the further lookup (illustrated in FIG. 8) can be used to identify a further prediction of an outcome of a second control flow altering instruction in a multi-taken sequence identified by that block.

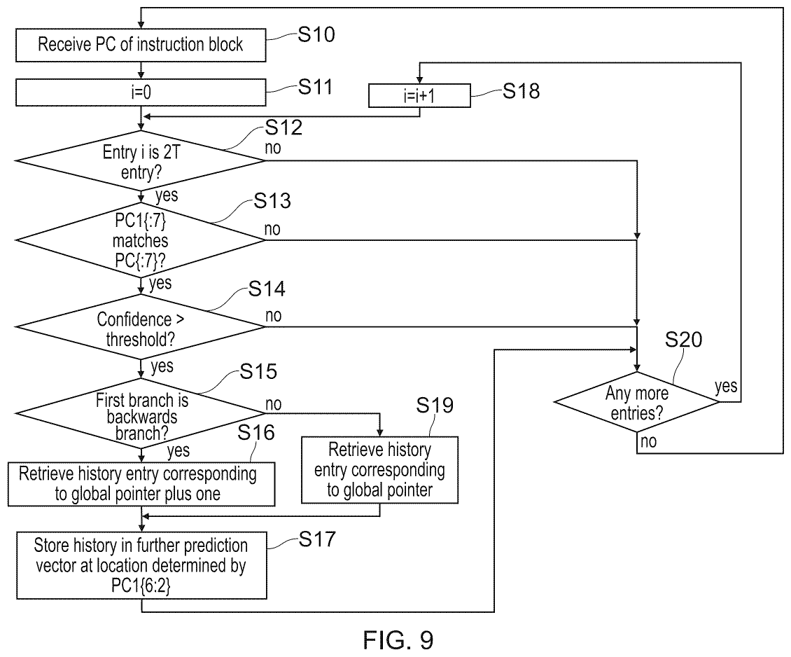

FIG. 9 schematically illustrates a sequence of steps carried out when performing a further lookup according to some configurations of the present techniques. Flow begins at step S10 where a program counter value indicative of a block of instructions is received. Flow then proceeds to step S11 where a counter i is reset (i=0). Flow then proceeds to step S12 where it is determined if entry i in the history storage circuitry is a multi-taken entry (2T entry). If, at step S12, it is identified that entry i is not a multi-taken entry, then flow proceeds to step S20 where it is determined if there are any more entries in the history storage circuitry. If, at step S20, it is determined that there are more entries in the history storage circuitry, then flow proceeds to step S18 where i is incremented before flow returns to step S12. If, at step S20, it is determined that there are no more entries in the history storage circuitry, then flow returns to step S10.

If, at step S12, it is determined that entry i is a multi-taken entry, then flow proceeds to step S13 where it is determined if most significant portion of the received PC of the instruction block matches the first program counter value in history record i. If, at step S13, it is determined that there is not a match, then flow proceeds to step S20 as described above. If, at step S13, it is determined that there is a match, then flow proceeds to step S14, where it is determined if the confidence associated with entry i exceeds a threshold. If, at step S14, it is determined that the confidence does not exceed a threshold, then flow proceeds to step S20 as described above. If, at step S14, it is determined that the confidence does exceed a threshold, then flow proceeds to step S15. At step S15, it is determined if the first branch identified in record i is a backwards taken branch. If, at step S15, it is determined that the first branch is not a backwards taken branch, then flow proceeds to step S19 where the history entry corresponding to the global pointer is retrieved from history record i. Flow then proceeds to step S17. If, at step S15, it is determined that the first branch is a backwards taken branch, then flow proceeds to step S16 where the history entry corresponding to the global pointer plus one is retrieved from history record i. Flow then proceeds to step S17.

At step S17 the history entry retrieved from history record i is stored in the further prediction history vector at a location determined by the offset of the first program counter stored in history record i. flow then proceeds to step S20 as described above.

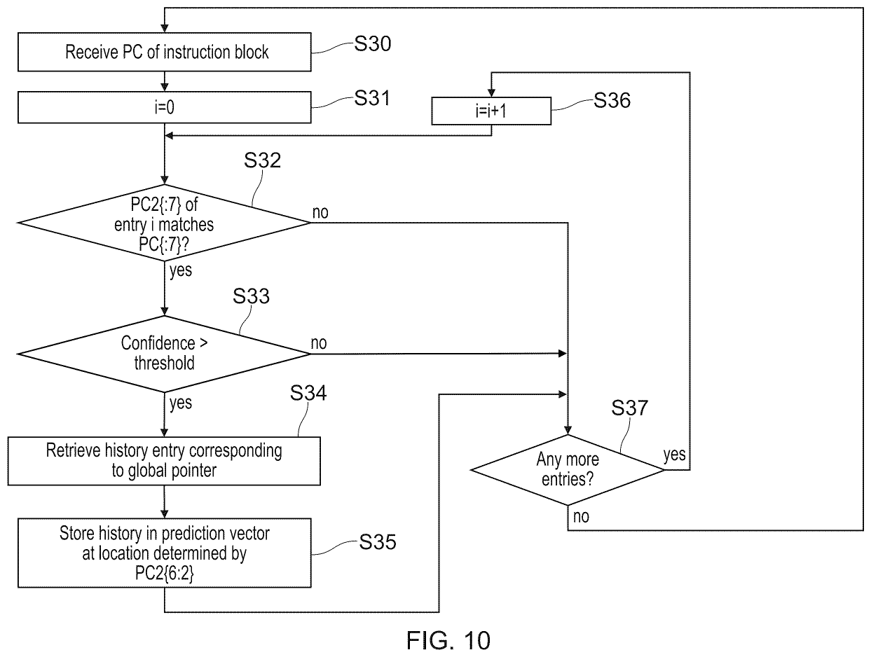

FIG. 10 schematically illustrates a sequence of steps carried out when performing a lookup according to some configurations of the present techniques. Flow begins at step S30 where a program counter value of a block of instructions is achieved. Flow then proceeds to step S31 where a counter i is reset (i=0). Flow then proceeds to step S32 where it is determined if the program counter value of the second instruction block in history entry i matches against the received program counter value. If, at step S32, there is not a match, then flow proceeds to step S37 where it is determined if there are any more entries in the history storage circuitry. If, at step S37, it is determined that there are more entries in the history storage circuitry, then flow proceeds to step S36 where i is incremented before flow returns to step S32. If, at step S37, it is determined that there are no more entries in the history storage circuitry, then flow returns to step S30.

If, at step S32, it is determined that there is a match, then flow proceeds to step S33, where it is determined if the confidence associated with entry i exceeds a threshold. If, at step S33, it is determined that the confidence does not exceed a threshold, then flow proceeds to step S37 as described above. If, at step S33, it is determined that the confidence does exceed a threshold, then flow proceeds to step S34 where the history entry corresponding to the global pointer is retrieved from history entry i. Flow then proceeds to step S35 where the history is stored in the prediction vector at a location determined by the offset of the second control flow altering instruction recorded in history entry i. Flow then proceeds to step S37 as described above.

It will be readily apparent to the person of ordinary skill in the art that the steps carried out for the further lookup (as illustrated in FIG. 9) and the steps carried out for the lookup (as illustrated in FIG. 10) may be carried out one after the other, in parallel or partially in parallel with one another. Furthermore, whilst the lookup and the further lookup are described as sequentially stepping through the history entries, one or more of the history entries (identified in FIGS. 9 and 10 by the index i) may be looked up in parallel with one another.

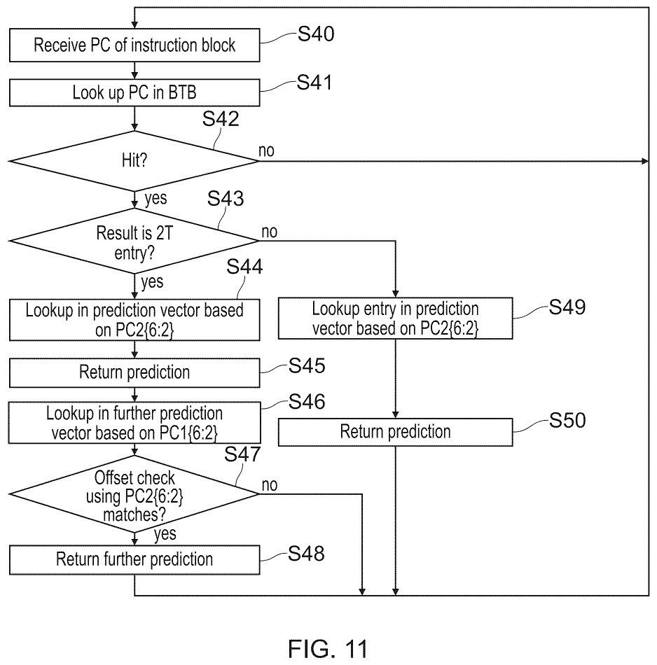

FIG. 11 schematically illustrates a sequence of steps carried out in relation to some configurations of the present techniques. Flow begins at step S40 where a program counter value of a block of instructions is retrieved. Flow then proceeds to step S41 where a lookup is performed in the branch target buffer (BTB). Flow then proceeds to step S42 where it is determined if there is a hit in the branch target buffer. If, at step S42, it is determined that there is not a hit in the branch target buffer, then flow returns to step S40 to await receipt of a program counter value of the next block of instructions.

If, at step S42, it is determined that there is a hit in the BTB, then flow proceeds to step S43 where it is determined if the hit is on a multi-taken (2T) entry. If, at step S43, it is determined that the hit is on an entry that is not a multi-taken entry, then flow proceeds to step S49. At step S49 a lookup is performed in the entry prediction vector based on the offset of the control flow altering instruction identified from the BTB (PC{6:2}) to retrieve a prediction. Flow then proceeds to step S50 where the prediction (which may include an indication of taken or not-taken or an indication that no valid prediction has been found) is returned (output).

If, at step S43 it is determined that the hit was on a multi-taken entry, then flow proceeds to step S44 where a lookup is performed in the prediction vector based on an address of the second control flow altering instruction identified in the multi-taken entry (PC2{6:2}). Flow then proceeds to step S45 where the prediction is returned. Flow then proceeds to step S46 where a lookup is performed in the further prediction vector based on an address of the first control flow altering instruction identified in the multi-taken entry (PC1{6:2}). Flow then proceeds to step S47 where an offset check is performed to determine if the offset for the second control flow altering instruction matches against the offset identified from the history record. If, at step S47, it is determined that there is no match, then flow returns to step S40. If, at step S47, it is determined that there is a match, then flow proceeds to step S48 where the prediction (which may include an indication of taken or not-taken or an indication that no valid prediction has been found) is returned before flow returns to step S40.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

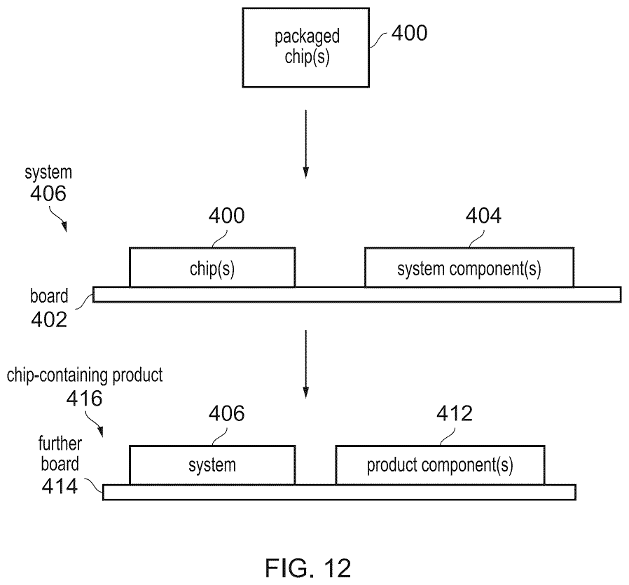

As shown in FIG. 12, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising history storage circuitry to store history records. Each history record is configured to support a multi-taken encoding identifying: first and second address identifiers of first and second control flow altering instructions, and a local history of changes in control flow resulting from the second control flow altering instruction. The apparatus is provided with pointer storage circuitry to store a global pointer. The apparatus is provided with prediction circuitry responsive to receipt of an address to identify a local history record for which the address corresponds to the second address identifier, and to provide a prediction based on the global pointer. The prediction circuitry is responsive to receipt of the address to identify a further local history record for which the address corresponds to the first address identifier, and to provide a further prediction based on the global pointer.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:
Clause 1. An apparatus comprising:
   history storage circuitry configured to store a plurality of history records, each history record configured to support a multi-taken encoding identifying:
      a first address identifier of a first control flow altering instruction;
      a second address identifier of a second control flow altering instruction, the second control flow altering instruction subsequent to the first control flow altering instruction; and
      a local history of successive changes in control flow resulting from the second control flow altering instruction;
   pointer storage circuitry configured to store a global pointer shared between said plurality of local history records, the global pointer indicative of a position in the local history identified in each of the local history records; and
   prediction circuitry responsive to receipt of a given instruction address to perform a lookup in the history storage circuitry to identify a local history record for which the given instruction address corresponds to the second address identifier, and when the lookup hits in the history storage circuitry, to provide a prediction of a change in control flow selected from the successive changes in control flow indicated in the local history record based on the global pointer,
   wherein the prediction circuitry is responsive to receipt of the given instruction address to perform a further lookup in the history storage circuitry to identify a further local history record for which the given instruction address corresponds to the first address identifier, and when the further lookup hits in the history storage circuitry, to provide a further prediction of a further change in control flow selected from the successive changes in control flow indicated in the further local history record based on the global pointer, the further change in control flow predicted to occur subsequent to the change in control flow.
Clause 2. The apparatus of clause 1, comprising:
   front end circuitry responsive to receipt of an instruction, to associate a tag value to the instruction during processing of the instruction, the tag value corresponding to the global pointer; and
   misprediction circuitry responsive to a misprediction detection for a given mispredicted instruction, to restore the global pointer in the pointer storage circuitry to a value determined based on the tag value associated with the given mispredicted instruction.
Clause 3. The apparatus of clause 1 or clause 2, wherein the pointer storage circuitry is configured to increment the global pointer in response to a control flow altering instruction causing a backwards change in program flow from a first instruction address to a second instruction address lower than the first instruction address.
Clause 4. The apparatus any preceding clause, wherein:
   the history storage circuitry is configured to store, in the encoding of the multi-taken entry, a backwards flow indication identifying whether the first control flow altering instruction caused a backwards change in program flow; and
   the prediction circuitry is configured, when providing the further prediction, to select the further change in control flow from the successive changes in control flow indicated in the further local history record based on the backwards flow indication.
Clause 5. The apparatus of clause 4, wherein the prediction circuitry is configured, when the backwards flow indication identifies that the first control flow altering instruction caused the backwards change in program flow, to select the further change in control flow based on the global pointer plus one.
Clause 6. The apparatus of any preceding clause, wherein:
   the given instruction address identifies a beginning of a block of instruction addresses; and
   the apparatus comprises target prediction circuitry, responsive to receipt of the given instruction address, to predict whether the block of instruction addresses comprises one or more control flow altering instructions, the target prediction circuitry configured, when the block of instruction addresses comprises one or more control flow altering instructions, to provide a prediction address of a predicted control flow altering instruction that is predicted to cause a non-sequential change in the control flow as a result of processing instructions in the block of instructions.
Clause 7. The apparatus of clause 6, wherein the prediction circuitry is configured to select at least one of the local history record and the further local history record based on the prediction address.
Clause 8. The apparatus of clause 6 or clause 7, wherein the target prediction circuitry supports an encoding of a target multi-taken entry identifying the first address identifier, the second address identifier, and a target address of the second control flow altering instruction.
Clause 9. The apparatus of clause 8, wherein the prediction address comprises a unique address of the second control flow altering instruction.
Clause 10. The apparatus of clause 9, wherein:
   the first address identifier comprises a subset of address bits of the first control flow altering instruction; and
   the prediction circuitry is configured to perform an anti-aliasing determination for the further local history record identified from the subset of address bits through comparison of the second address identified in the local history record against the prediction address.
Clause 11. The apparatus of any preceding clause, wherein each of the plurality of history records comprises a confidence indication indicative of a confidence in the successive changes in control flow.
Clause 12. The apparatus of clause 11, comprising:
   additional prediction circuitry configured to provide an additional prediction of an outcome of control flow altering instructions based on a global history; and
   control circuitry configured to select between predictions generated by the additional prediction circuitry and predictions generated by the prediction circuitry based on the confidence indication of the given local history record selected in the prediction.
Clause 13. The apparatus of clause 12, wherein
   the apparatus comprises control circuitry is configured to store a replay indication indicative of whether a replay condition is satisfied and, when the replay indication indicates that the replay condition is not satisfied, to select the additional prediction.
Clause 14. The apparatus according to clause 13, wherein the replay condition is satisfied when the control circuitry detects that the given instruction address represents a block of one or more instructions including a replayed instruction to be re-executed following detection of a misprediction associated with an earlier instruction than the replayed instruction.
Clause 15. The apparatus of any of clauses 12 to 14, wherein the additional prediction circuitry is tagged geometric history length (TAGE) prediction circuitry configured to predict whether conditional control flow altering instructions will be taken or not based on a plurality of TAGE tables tagged by a range of lengths of execution history.
Clause 16. The apparatus of clause 15, wherein the execution history is a global execution history.
Clause 17. A system comprising:
   the apparatus of any preceding clause, implemented in at least one packaged chip;
   at least one system component; and
   a board,
   wherein the at least one packaged chip and the at least one system component are assembled on the board.
Clause 18. A chip-containing product comprising the system of clause 17, wherein the system is assembled on a further board with at least one other product component.
Clause 19. A method comprising:
storing, in history storage circuitry, a plurality of history records, each history record configured to support a multi-taken encoding identifying:
   a first address identifier of a first control flow altering instruction;
   a second address identifier of a second control flow altering instruction, the second control flow altering instruction subsequent to the first control flow altering instruction; and
   a local history of successive changes in control flow resulting from the second control flow altering instruction;
storing a global pointer shared between said plurality of local history records, the global pointer indicative of a position in each the local history identified in each of the local history records; and
in response to receipt of a given instruction address, performing a lookup in the history storage circuitry to identify a local history record for which the given instruction address corresponds to the second address identifier, and when the lookup hits in the history storage circuitry, providing a prediction of a change in control flow selected from the successive changes in control flow indicated in the local history record based on the global pointer,
in response to receipt of the given instruction address to perform a further lookup in the history storage circuitry, identifying a further local history record for which the given instruction address corresponds to the first address identifier, and when the further lookup hits in the history storage circuitry, providing a further prediction of a further change in control flow selected from the successive changes in control flow indicated in the further local history record based on the global pointer, the further change in control flow predicted to occur subsequent to the change in control flow.
Clause 20. A non-transitory computer-readable medium storing computer-readable code for fabrication of the apparatus of any of clauses 1 to 16.

We claim:

1. An apparatus comprising:
history storage circuitry configured to store a plurality of history records, each history record configured to support a multi-taken encoding identifying:
a first address identifier of a first control flow altering instruction;
a second address identifier of a second control flow altering instruction, the second control flow altering instruction subsequent to the first control flow altering instruction; and
a local history of successive changes in control flow resulting from the second control flow altering instruction;
pointer storage circuitry configured to store a global pointer shared between said plurality of local history records, the global pointer indicative of a position in the local history identified in each of the local history records; and
prediction circuitry responsive to receipt of a given instruction address to perform a lookup in the history storage circuitry to identify a local history record for which the given instruction address corresponds to the second address identifier, and when the lookup hits in the history storage circuitry, to provide a prediction of a change in control flow selected from the successive changes in control flow indicated in the local history record based on the global pointer,
wherein the prediction circuitry is responsive to receipt of the given instruction address to perform a further lookup in the history storage circuitry to identify a further local history record for which the given instruction address corresponds to the first address identifier, and when the further lookup hits in the history storage circuitry, to provide a further prediction of a further change in control flow selected from the successive changes in control flow indicated in the further local history record based on the global pointer, the further change in control flow predicted to occur subsequent to the change in control flow.

2. The apparatus of claim 1, comprising:
front end circuitry responsive to receipt of an instruction, to associate a tag value to the instruction during processing of the instruction, the tag value corresponding to the global pointer; and
misprediction circuitry responsive to a misprediction detection for a given mispredicted instruction, to restore the global pointer in the pointer storage circuitry to a value determined based on the tag value associated with the given mispredicted instruction.

3. The apparatus of claim 1, wherein the pointer storage circuitry is configured to increment the global pointer in response to a control flow altering instruction causing a backwards change in program flow from a first instruction address to a second instruction address lower than the first instruction address.

4. The apparatus of claim 1, wherein:
the history storage circuitry is configured to store, in the encoding of the multi-taken entry, a backwards flow indication identifying whether the first control flow altering instruction caused a backwards change in program flow; and
the prediction circuitry is configured, when providing the further prediction, to select the further change in control flow from the successive changes in control flow indicated in the further local history record based on the backwards flow indication.

5. The apparatus of claim 4, wherein the prediction circuitry is configured, when the backwards flow indication identifies that the first control flow altering instruction caused the backwards change in program flow, to select the further change in control flow based on the global pointer plus one.

6. The apparatus of claim 1, wherein:
the given instruction address identifies a beginning of a block of instruction addresses; and
the apparatus comprises target prediction circuitry, responsive to receipt of the given instruction address, to predict whether the block of instruction addresses comprises one or more control flow altering instructions, the target prediction circuitry configured, when the block of instruction addresses comprises one or more control flow altering instructions, to provide a prediction address of a predicted control flow altering instruction that is predicted to cause a non-sequential change in the control flow as a result of processing instructions in the block of instructions.

7. The apparatus of claim 6, wherein the prediction circuitry is configured to select at least one of the local history record and the further local history record based on the prediction address.

8. The apparatus of claim 6, wherein the target prediction circuitry supports an encoding of a target multi-taken entry identifying the first address identifier, the second address identifier, and a target address of the second control flow altering instruction.

9. The apparatus of claim 8, wherein the prediction address comprises a unique address of the second control flow altering instruction.

10. The apparatus of claim 9, wherein:
the first address identifier comprises a subset of address bits of the first control flow altering instruction; and
the prediction circuitry is configured to perform an anti-aliasing determination for the further local history record identified from the subset of address bits through comparison of the second address identified in the local history record against the prediction address.

11. The apparatus of claim 1, wherein each of the plurality of history records comprises a confidence indication indicative of a confidence in the successive changes in control flow.

12. The apparatus of claim 11, comprising:
additional prediction circuitry configured to provide an additional prediction of an outcome of control flow altering instructions based on a global history; and
control circuitry configured to select between predictions generated by the additional prediction circuitry and predictions generated by the prediction circuitry based on the confidence indication of the given local history record selected in the prediction.

13. The apparatus of claim 12, wherein
the apparatus comprises control circuitry is configured to store a replay indication indicative of whether a replay condition is satisfied and, when the replay indication indicates that the replay condition is not satisfied, to select the additional prediction.

14. The apparatus according to claim 13, wherein the replay condition is satisfied when the control circuitry detects that the given instruction address represents a block of one or more instructions including a replayed instruction to be re-executed following detection of a misprediction associated with an earlier instruction than the replayed instruction.

15. The apparatus of claim 12, wherein the additional prediction circuitry is tagged geometric history length (TAGE) prediction circuitry configured to predict whether conditional control flow altering instructions will be taken or not based on a plurality of TAGE tables tagged by a range of lengths of execution history.

16. The apparatus of claim 15, wherein the execution history is a global execution history.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
storing, in history storage circuitry, a plurality of history records, each history record configured to support a multi-taken encoding identifying:
a first address identifier of a first control flow altering instruction;
a second address identifier of a second control flow altering instruction, the second control flow altering instruction subsequent to the first control flow altering instruction; and
a local history of successive changes in control flow resulting from the second control flow altering instruction;
storing a global pointer shared between said plurality of local history records, the global pointer indicative of a position in each the local history identified in each of the local history records; and
in response to receipt of a given instruction address, performing a lookup in the history storage circuitry to identify a local history record for which the given instruction address corresponds to the second address identifier, and when the lookup hits in the history storage circuitry, providing a prediction of a change in control flow selected from the successive changes in control flow indicated in the local history record based on the global pointer,
in response to receipt of the given instruction address to perform a further lookup in the history storage circuitry, identifying a further local history record for which the given instruction address corresponds to the first address identifier, and when the further lookup hits in the history storage circuitry, providing a further prediction of a further change in control flow selected from the successive changes in control flow indicated in the further local history record based on the global pointer, the further change in control flow predicted to occur subsequent to the change in control flow.

20. A non-transitory computer-readable medium storing computer-readable code for fabrication of an apparatus comprising:
history storage circuitry configured to store a plurality of history records, each history record configured to support a multi-taken encoding identifying:
a first address identifier of a first control flow altering instruction;
a second address identifier of a second control flow altering instruction, the second control flow altering instruction subsequent to the first control flow altering instruction; and
a local history of successive changes in control flow resulting from the second control flow altering instruction;
pointer storage circuitry configured to store a global pointer shared between said plurality of local history records, the global pointer indicative of a position in each the local history identified in each of the local history records; and
prediction circuitry responsive to receipt of a given instruction address to perform a lookup in the history storage circuitry to identify a local history record for which the given instruction address corresponds to the second address identifier, and when the lookup hits in the history storage circuitry, to provide a prediction of a change in control flow selected from the successive changes in control flow indicated in the local history record based on the global pointer,
wherein the prediction circuitry is responsive to receipt of the given instruction address to perform a further lookup in the history storage circuitry to identify a further local history record for which the given instruction address corresponds to the first address identifier, and when the further lookup hits in the history storage circuitry, to provide a further prediction of a further change in control flow selected from the successive changes in control flow indicated in the further local history record based on the global pointer, the further change in control flow predicted to occur subsequent to the change in control flow.
